(19) United States
(12) Patent Application Publication
(10) Pub. No.: US 2022/0406117 A1
(43) Pub. Date: Dec. 22, 2022

(54) COUNTER-TERRORISM CURRENCY SYSTEM

(71) Applicant: ELISHA TWENEBOAH KODUA, Kyle, TX (US)

(72) Inventor: ELISHA TWENEBOAH KODUA, Kyle, TX (US)

(21) Appl. No.: 17/350,118

(22) Filed: Jun. 17, 2021

(51) Int. Cl. G07D 7/004; G07D 7/00; G07D 7/17

(52) U.S. Cl. CPC G07D 7/004; G07D 7/003; G07D 7/17

(57) ABSTRACT

The Counter-Terrorism Currency System is a type of currency designed to combat financial fraud and Terrorism. The Counter-Terrorism Currency System is also known as the CT Currency System

The CT Currency will be in two forms.

The CT Paper Currency and the CT Digital Currency

The CT paper Currency will be paper money with an embedded CT Code, which stands for “Counter-Terrorism Code. “This CT code allows users to scan the CT paper currency with their smartphone through the CT Currency Mobile App.

Both sides of the CT paper Currency will be embedded with the CT code. one side is for transactions, and the other is for the bank used only. The bank used the only section used by the bank whenever the paper gets lost to find the rightful owner.

### BACKGROUND OF THE INVENTION COUNTER—TERRORISM CURRENCY SYSTEM

Any nation across the globe cannot overlook the growing Terrorism in the world today and the increase of financial fraud both Online and off-line. Everyone is vulnerable irrespective of stature, position, age, sex, and culture. There have been numerous terrorist attacks even on the nation's Currency, where we often hear of fake currency manufacturing that hurt the nation's economy. The introduction of the Counter-Terrorism Currency System also known as the CT Currency System will go a long way to combat such terrorist attacks and other financial frauds.

### DETAIL DESCRIPTION

The Counter-Terrorism Currency System is a type of Currency designed to combat financial fraud and Terrorism. The CT Currency System is a kind of Currency embedded with the Counter-Terrorism Code (CT Code), which enables the paper currency to be scanned with a smartphone through the Counter-Terrorism Currency Mobile Application.

The CT Currency will be in two forms.

The CT Paper Currency and the CT Digital Currency

The CT paper Currency will be paper money with an embedded CT Code, which stands for “Counter-Terrorism Code. “This CT code allows users to scan the CT paper currency with their smartphone through the CT Currency Mobile App.

Both sides of the CT paper Currency will be embedded with the CT code. one side is for transactions, and the other is for the “bank or merchant use only”. The “bank or merchant use only” section is used by the bank or merchant whenever the CT paper currency gets lost, to find the rightful owner. As soon as the Bank or merchant scans this side, the information of the person or a company in which the money is registered to, will be displayed. The inscription, “Bank or merchant use only” will be written on the side on the side of the CT paper currency to differentiate between the customer side and the merchant side. The CT paper Currency will only work through the CT Currency Mobile App. It will not work without scanning through the CT Mobile App. The customer will have to open the Mobile App before scanning the CT paper Currency.

In other words, the CTC paper currency will be valueless without the CT Currency Mobile App.

### The CT Currency Mobile Application

In order to use the CT Currency System, the user will have to download the CT Currency Mobile App and sign up to control or manage funds. The user will go through a security check and verify a valid Government-issued identification and allow at least a 24-hour window for the verification team to verify their account for approval. Upon approval, the user will have an option to add their bank account to the Mobile App and can manage their funds.

### Making and Receiving Payments with the CT Currency

Users who want to make a payment or receive funds with CT Currency Mobile App will present the money to the merchant, and the merchant will scan the CT Code with their smart device. As the merchant scans the code, the system will prompt the buyer to enter the pin selected when he first registers the CT Currency Mobile App.

Upon entering a successful pin, the user will be able to have access to the funds. If the buy is due to change after transactions, the merchant will have an option with the CT Currency Mobile APP to send the change or refund the customer with a CT Paper Currency or CT Digital Currency. If the customer chooses to receive a refund by CT Paper Currency, the cashier or merchant will scan one paper currency and ask the customer to enter their pin to receive the funds. Once they enter their pin successfully, they will be issued the funds. The same is true in giving a refund via CT Digital Currency. As soon as the customer enters their pin, the funds will be made available to their CT Digital Currency balance.

### Different Bills of the CT Paper Currency

The CT Currency will maintain the already available paper Currency bills from a dollar bill to 100-dollar bill or which one may be the maximum paper bill in the future.

There is an option to update quantity bills on your CT Currency account.

For instance, to make payment with the CT paper Currency for $500, the customer will issue only one $100 paper bill. As soon as the merchant scans the CT paper Currency, the customer will be allowed to enter the bills needed to make payment. The customer can decide to pay with the bills in hand or through their CT Digital Currency account via the CT Currency Mobile App or both.

The system will also display all the available CT paper Currency bills from a dollar bill to a 100-dollar bill available in the customer's account. When the quantity is selected, the customer will approve the transaction by entering their pin.

### Lost or Stolen of the CT Currency

If the account holder loses his funds or misplaces his funds, or even steals the funds from the owner, the person will never be able to use the funds without the actual owner's pin.

All stolen CT Paper currencies found cannot be used and must therefore be taken to the bank. The bank will now scan the CT Code on the other side of the cash to determine who the money was registered and contact the person to come for it.

If someone by any means gets hold of your information and withdraws your funds, the system will detect where the funds were used.

Users will have an option to report unauthorized payment through the CT Currency Mobile App.

### Making Banks Withdrawals with CT Currency

When the user goes to the bank to withdraw or deposit funds to their digital account or request a CT paper Currency, the bank will verify the customer's government-issued identification and ensure the information matches the CT Currency Mobile Application and those in their system. Before issuing funds. The customer will now be prompted on the CT Currency Mobile App to enter their pin to receive funds.

The exact process will be used to debit funds from the customer's account for deposit.

If a customer decides to withdraw funds from the ATM with their CTC currency mobile App, the customer will have to open the App and scan the bar-code at the ATM, and the customer will be allowed to enter their ATM pin.

After the pin, they will need to follow the instructions on the screen to either withdraw or deposit funds. Whichever they choose, the CT Currency Mobile App will prompt the customer to enter their pin to receive funds or allow withdrawal from the ATM.

### Devices to Use for the CT Currency System

All users will use their smartphones to download the CT Currency Mobile App to use the system.

However, there will be a unique device for merchants and banks to manage their funds.

The device will have a pre-installed CT Currency Mobile App filled with the following functions and capabilities.

1. The merchant will use their device to trace the person to whom the paper currency is registered.

2. Ability to scan one bill to unveils all funds to make quick customer payment.

3. Ability to link all employees account and pay them with a single click

### SUMMARY OF THE INVENTION

he Counter-Terrorism Currency System is a type of Currency designed to combat financial fraud and Terrorism. The Counter-Terrorism Currency System is also known as the CT Currency System. It is a kind of Currency embedded with the Counter-Terrorism Code, which enables the paper currency to be scanned with a smartphone through the Counter-Terrorism Currency Mobile Application. The CT Currency will be in two forms.

The CT Paper Currency and the CT Digital Currency. The CT paper Currency will only work through the CT Currency Mobile App. The user will have to download the CT Currency Mobile App and sign up to control or manage funds. Users who want to make a payment or receive funds with CT Currency Mobile App will present the money to the merchant, and the merchant will scan the CT Code with their smart device. If the account holder loses his funds or misplaces his funds, or even steals the funds from the owner, the person will never be able to use the funds without the actual owner's pin.

All stolen CT Paper currencies found cannot be used and must therefore be taken to the bank

I. The Counter-Terrorism Currency is a kind of Currency embedded with the Counter-Terrorism Code, which enables the paper currency to be scanned with a smartphone through the Counter-Terrorism Currency Mobile Application.

II. Users can make and receive funds by simply scanning the Counter-Terrorism Currency Code (CT Code) on the Counter-Terrorism paper Currency with their smartphone. The money will be added or debited from their bank account or Online payment account.

III. Merchants will have the ability to trace the lost or missing funds through the Counter-Terrorism Currency Mobile Application
